(19) United States
(12) Patent Application Publication
(10) Pub. No.: US 2014/0116752 A1
(43) Pub. Date: May 1, 2014

(54) LOWER FIREWALL PLATE GROMMET

(71) Applicant: UNITED TECHNOLOGIES CORPORATION, Hartford, CT (US)

(72) Inventors: Joseph J. Sodaro, Coventry, CT (US); John Tomasulo, Clay, NY (US)

(73) Assignee: UNITED TECHNOLOGIES CORPORATION, Hartford, CT (US)

(21) Appl. No.: 13/663,600

(22) Filed: Oct. 30, 2012

(51) Int. Cl. H01B 17/58

(52) U.S. Cl. 174/153 G

(57) ABSTRACT

A grommet for an aircraft fire seal has multiple grommet layers. Each of the grommet layers includes a thickness and a complex geometrical face normal to the thickness.

### BACKGROUND OF THE INVENTION

The present disclosure relates generally to aircraft fire seals, and particularly to a fire seal grommet for a lower firewall plate in an aircraft.

Modern aircraft engines, such as those incorporated in commercial aircraft, include a gas turbine engine core surrounded by an engine nacelle. In order to control the engine core, a wiring harness provides electrical connections between multiple varied gas turbine engine systems and to at least one aircraft controller. Access to both the wiring harness and the engine core is provided by an access hatch on the engine nacelle. The wiring harness runs wire bundles through the engine, adjacent to the engine core.

In order to prevent engine fires from travelling from a first engine component to a second engine component along the wire bundle pathways, fire seals separate the various engine components from each other. Fire seals are located in both the engine core and within the nacelle. The Fire seal located where the nacelle doors close together are referred to as a “lower firewall” and necessarily must accommodate wiring bundles passing through the engine and connecting the various engine components.

### SUMMARY OF THE INVENTION

According to an exemplary embodiment of this disclosure, among other possible things a gas turbine engine includes, an engine core, a nacelle at least partially surrounding the engine core, a wiring harness located at least partially in the nacelle, the wiring harness comprises electrical leads connecting to multiple engine core components, a fire seal sealing a wire harness passageway in the nacelle, the fire seal comprises at least one grommet, and the at least one grommet is constructed of a plurality of layers.

In a further embodiment of the foregoing gas turbine engine, each of the plurality of layers has a uniform thickness.

In a further embodiment of the foregoing gas turbine engine, the plurality of layers comprises at least a first plurality of layers having a planar cross section normal to the thickness and a second plurality of layers having a planar cross section normal to the thickness, the planar cross section of the first plurality of layers has a first shape and the planar cross section of the second plurality of layers has a second shape different from the first shape.

In a further embodiment of the foregoing gas turbine engine, the plurality of layers are stacked adjacent to each other such that a planar face of each layer, normal to the thickness, contacts a planer face, normal to the thickness, of an adjacent layer.

In a further embodiment of the foregoing gas turbine engine, each of the plurality of layers includes at least a first wire harness hole aligned with the thickness, and each of the first wire harness holes are aligned to form a through hole in the fire seal grommet.

In a further embodiment of the foregoing gas turbine engine, each of the layers further includes a harness installation gap extending from each of the at least one holes to an outer circumferential edge of the layer, and each of the harness installation gaps is clamped closed when the wiring harness is fully installed.

In a further embodiment of the foregoing gas turbine engine, each of the at least one grommets includes a cut out region for accommodating a fire seal feature, and the cut out region results in a complex three dimensional geometry.

In a further embodiment of the foregoing gas turbine engine, each of the layers comprises a fire retardant rubber layer.

According to an exemplary embodiment of this disclosure, among other possible things a grommet for an aircraft fire seal includes, a plurality of grommet layers, each of the layers has a thickness and complex geometry face normal to the thickness.

In a further embodiment of the foregoing grommet, each of the plurality of layers has the same thickness.

In a further embodiment of the foregoing grommet, the plurality of layers includes at least a first plurality of layers having a planar cross section normal to the thickness and a second plurality of layers having a planar cross section normal to the thickness, the planar cross section of the first plurality of layers has a first shape and the planar cross section of the second plurality of layers has a second shape different from the first shape.

In a further embodiment of the foregoing grommet, the plurality of layers are stacked adjacent to each other such that a planar face of each layer, normal to the thickness, contacts a planer face, normal to the thickness, of an adjacent layer.

In a further embodiment of the foregoing grommet, each of the plurality of layers includes at least a first wire harness hole aligned with the thickness, and each of the first wire harness holes are aligned to form a through hole in the fire seal grommet.

In a further embodiment of the foregoing grommet, each of the layers further includes a harness installation gap extending from each of the at least one holes to an outer circumferential edge of the layer, and each of the harness installation gaps is clamped closed when the wiring harness is fully installed.

In a further embodiment of the foregoing grommet, the grommet includes a cut out region for accommodating a fire seal feature, and the cut out region results in a complex three dimensional geometry.

In a further embodiment of the foregoing grommet, each of the layers comprises a fire retardant rubber layer.

These and other features of this application will be best understood from the following specification and drawings, the following of which is a brief description.

### BRIEF DESCRIPTION OF THE DRAWINGS

FIG. 1 schematically illustrates a gas turbine engine.

FIG. 2 schematically illustrates an isometric view of a lower firewall plate for use in an aircraft engine.

FIG. 3 schematically illustrates a zoomed in partial isometric view of the lower firewall plate of FIG. 2.

FIG. 4 illustrates an individual grommet layer for use in the lower firewall plate of FIG. 2.

FIG. 5 illustrates an alternate individual grommet layer for use in the lower firewall plate of FIG. 2.

### DETAILED DESCRIPTION

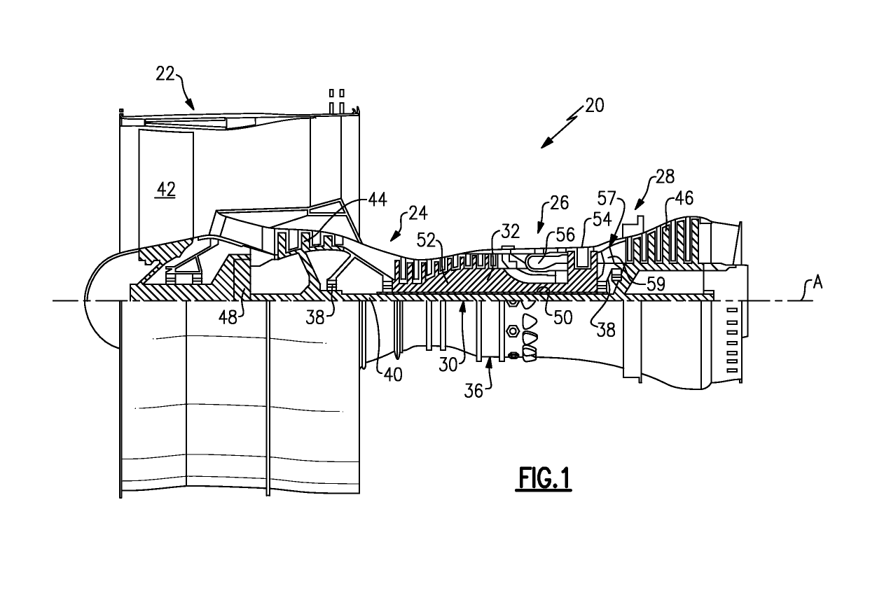

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath B in a bypass duct defined within a nacelle 15, while the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)] 0.5. The “Low corrected fan tip speed” as disclosed herein according to one non-limiting embodiment is less than about 1150 ft/second.

Turbine engines, such as the one described above, include fire seals separating the engine segments. The fire seals ensure that if a fire occurs in one segment, the fire does not spread to adjacent segments. The fire seals are located in the turbine engine 20 itself, as well as in the nacelle structure surrounding the turbine engine 20.

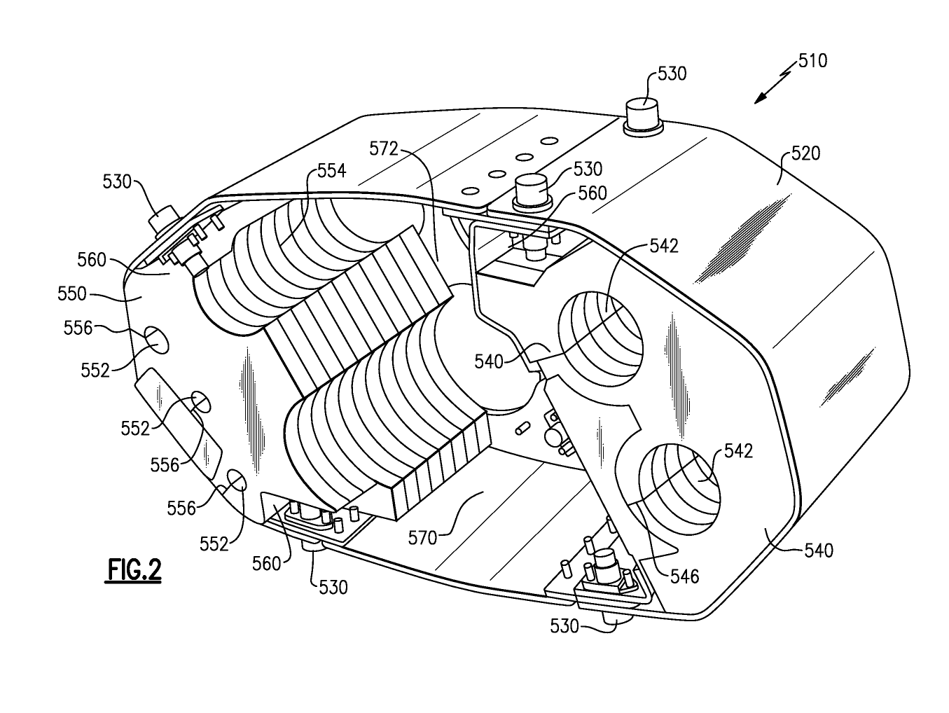

The fire seal where the nacelle doors close together are referred to as “lower firewall seals” and are designed to allow a wire bundle from a wiring harness to pass through the lower firewall seal without allowing fire to pass through the lower firewall plate. FIG. 2 illustrates an example lower firewall plate 510. The lower firewall plate 510 is constructed of multiple metal plates 520 and multiple fire seal grommets 540, 550. Metal plates 520 are connected together using fasteners 530 such as bolts, screws, or any other known fasteners. The fire seal grommets 540, 550 are contained within the metal plates 520

The fire seal grommets 540, 550 are constructed of a heavy duty rubber, or any other semi-flexible fireproof material. Between the fire seal grommets 540, 550 is an open area 570 that receives various pipes and other connections. The open area 570 is terminated on one end by a fireplate 572 that prevents fire from passing through the open area.

The fire seal grommets 540, 550 include through holes 542, 552 that receive wire bundles from an engine wiring harness. Each of the through holes 542, 552 includes a corresponding harness installation gap 546, 556. The harness installation gap 546, 556 is stretched open during installation of the wiring harness to allow a wire bundle to be slid into the corresponding through hole 542, 552. Once the wire bundle is positioned in the through hole 542, 552, the grommet 540, 550 is allowed to return to the illustrated relaxed position. When in the relaxed position, the through hole 542, 552 forms a tight fit around the wire bundle and prevents a fire from passing through the through hole 542.

Each of the fire seal grommets 540, 550 also includes cut out regions 560 that accommodate the fasteners 530 without affecting the integrity of the fire seal 510. As described above, the fire seal grommets 540, 550 are constructed of a heavy duty rubber material that is fireproof. Traditionally, in order to form complex three-dimensional configurations, such as the cut-away grommet shape of each of the grommets 540, 550, an expensive and time consuming molding process was utilized. In contrast to the previous process, the illustrated grommets 540, 550 are constructed from multiple layers of the fireproof material. Each of the layers has a uniform thickness and a single complex face that is normal to the thickness. The layers are then stacked to form the complex three dimensional configuration.

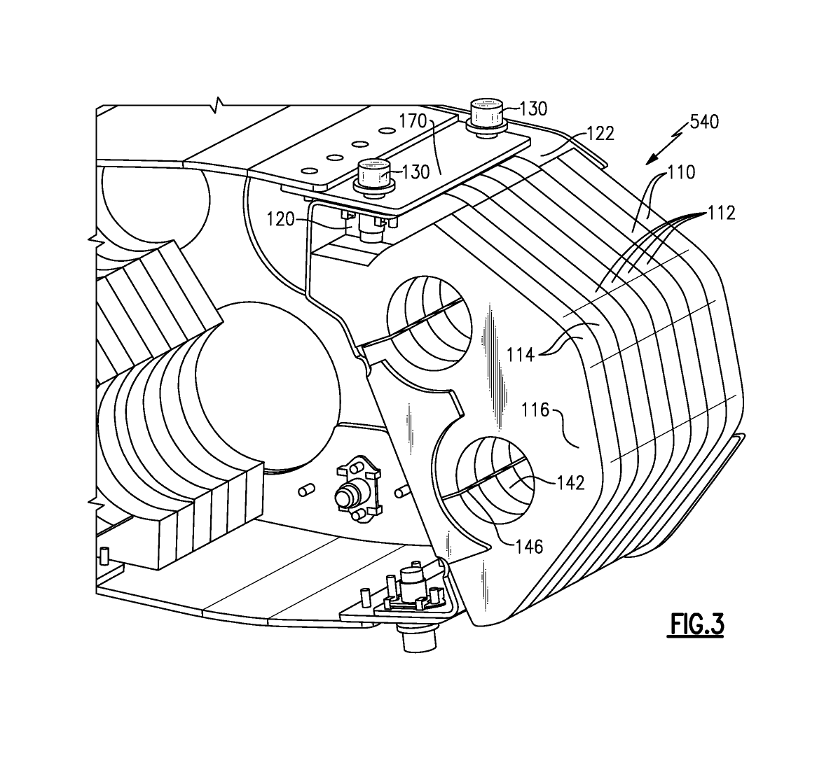

FIG. 3 illustrates the grommet 540 of FIG. 2 zoomed in and in greater detail. As described above, the grommet 540 is constructed of multiple layers 110, 112, 114. Each of the layers 110, 112, 114, has a uniformed thickness along an axis defined by the through holes 142. Each of the layers 110, 112, 114 has a cross sectional face 116 in a plane normal to the thickness of the layer 110, 112, 114. The front most layers 110 include a cut out region 120 that allows the assembled grommet 540 to accommodate the fasteners 130. The center layers 112 do not include the cut out region 120, and allow the fire seal grommet 540 to fully seal against a metal plate 170. The back layers 114 incorporate a similar cut out region 122 to accommodate a fastener 130.

Utilizing a layered grommet 540 design allows the grommet 540 to be cut from a single sheet of material having a uniform thickness. In this way only a single complicated face is required for each layer, and the grommet 540 can still to account for three dimensional features such as fasteners 130.

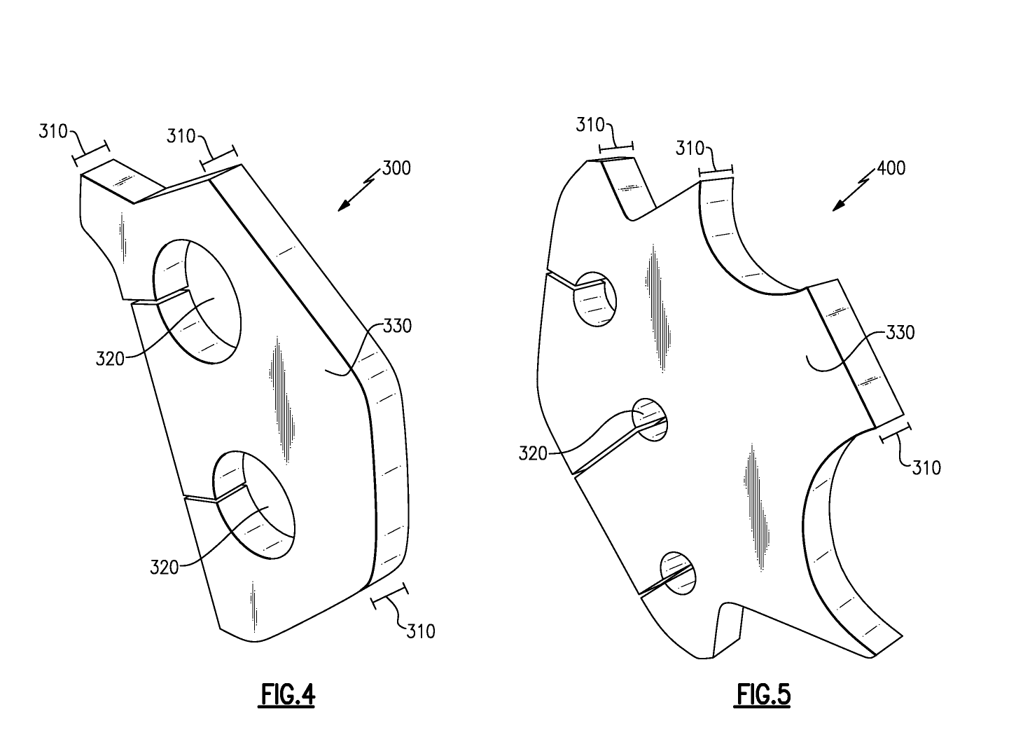

In an alternate configuration, the layers 110, 112, 114 can be cut from material sheets having different thicknesses. In both the standard configuration and the alternate configuration, the material sheets from which the layers 110, 112, 114 are cut are uniform thickness throughout a single sheet. FIGS. 4 and 5 schematically illustrate individual grommet layers 300, 400 with like numerals indicating like elements. As described previously, each grommet layer 300, 400 has a uniform thickness 310. Multiple through holes 320 are cut into the layer 300, 400 to allow for wire bundles to be passed through the grommet layer 300, 400. The through holes define an axis that is aligned with the thickness 310 of the grommet layer 300, 400. Each grommet layer 300, 400 has a face 330 with a complicated geometry. As described above, a grommet can be constructed with a complex three dimensional geometry from relatively simple to manufacture pieces due to the layered construction.

The fire seal grommet 540 illustrated in FIG. 3 is constructed using multiple layers 110, 112, 114 with each layer having a different complex geometry shape and still having a uniform thickness 310. In the instant example of FIG. 3, the fire seal grommet includes two iterations of the fire seal layer 300 illustrated in FIG. 4 with four iterations of a fire seal layer that lacks the cut out region 340 which is then followed by two sections of the fire seal layer 300. Each of the layers 110, 112, 114 in the fire seal grommet are held together via mechanical features of the lower firewall plate. In an alternate example, each of the fire seal layers are held together by an adhesive and the mechanical features of the lower firewall plate are not required.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an engine core;
a nacelle at least partially surrounding said engine core;
a wiring harness located at least partially in said nacelle, wherein said wiring harness comprises electrical leads connecting to multiple engine core components;
a fire seal sealing a wire harness passageway in said nacelle, wherein said fire seal comprises at least one grommet, and wherein said at least one grommet is constructed of a plurality of layers.

2. The gas turbine engine of claim 1, wherein each of said plurality of layers has a uniform thickness.

3. The gas turbine engine of claim 2, wherein said plurality of layers comprises at least a first plurality of layers having a planar cross section normal to said thickness and a second plurality of layers having a planar cross section normal to said thickness, wherein said planar cross section of said first plurality of layers has a first shape and said planar cross section of said second plurality of layers has a second shape different from said first shape.

4. The gas turbine engine of claim 2, wherein said plurality of layers are stacked adjacent to each other such that a planar face of each layer, normal to said thickness, contacts a planer face, normal to said thickness, of an adjacent layer.

5. The gas turbine engine of claim 2, wherein each of said plurality of layers comprises at least a first wire harness hole aligned with said thickness, and wherein each of said first wire harness holes are aligned to form a through hole in said fire seal grommet.

6. The gas turbine engine of claim 5, wherein each of said layers further comprises a harness installation gap extending from each of said at least one holes to an outer circumferential edge of said layer, and wherein each of said harness installation gaps is clamped closed when said wiring harness is fully installed.

7. The gas turbine engine of claim 1, wherein each of said at least one grommet comprises a cut out region for accommodating a fire seal feature, and wherein said cut out region results in a complex three dimensional geometry.

8. The gas turbine engine of claim 1, wherein each of said layers comprises a fire retardant rubber layer.

9. A grommet for an aircraft fire seal comprising:
a plurality of grommet layers, wherein each of said layers has a thickness and complex geometry face normal to said thickness.

10. The grommet of claim 9, wherein each of said plurality of layers has the same thickness.

11. The grommet of claim 10, wherein said plurality of layers comprises at least a first plurality of layers having a planar cross section normal to said thickness and a second plurality of layers having a planar cross section normal to said thickness, wherein said planar cross section of said first plurality of layers has a first shape and said planar cross section of said second plurality of layers has a second shape different from said first shape.

12. The grommet of claim 10, wherein said plurality of layers are stacked adjacent to each other such that a planar face of each layer, normal to said thickness, contacts a planer face, normal to said thickness, of an adjacent layer.

13. The grommet of claim 10, wherein each of said plurality of layers comprises at least a first wire harness hole aligned with said thickness, and wherein each of said first wire harness holes are aligned to form a through hole in said fire seal grommet.

14. The grommet of claim 13, wherein each of said layers further comprises a harness installation gap extending from each of said at least one holes to an outer circumferential edge of said layer, and wherein each of said harness installation gaps is clamped closed when said wiring harness is fully installed.

15. The grommet of claim 9, wherein said grommet comprises a cut out region for accommodating a fire seal feature, and wherein said cut out region results in a complex three dimensional geometry.

16. The grommet of claim 9, wherein each of said layers comprises a fire retardant rubber layer.
